(19) United States
(12) Patent Application Publication
(10) Pub. No.: US 2013/0106661 A1
(43) Pub. Date: May 2, 2013

(54) CASE OR ATTACHMENT FOR AN ELECTRONIC COMMUNICATIONS DEVICE

(71) Applicant: Xin Xiang, Brighton (AU)

(72) Inventor: Xin Xiang, Brighton (AU)

(73) Assignee: Classic Promotions Pty Ltd, Brighton (AU)

(21) Appl. No.: 13/581,581

(22) PCT Filed: Jul. 6, 2012
(86) PCT No.: PCT/AU12/00823

§ 371 Date: Aug. 28, 2012

(30) Foreign Application Priority Data
Jul. 7, 2011 (AU) 2011203352

(51) Int. Cl. H01Q 1/24

(52) U.S. Cl. CPC H01Q 1/245
USPC 343/702

(57) ABSTRACT

A case or attachment for an electronic communications device including added materials that exhibit dielectric properties and a passive antenna either incorporated within or affixed to the case or attachment and held in sufficiently close proximity to the electronic communications device such that the passive antenna is electromagnetically coupled to the device, the arrangement reducing the radiation directed toward a user.

### FIELD OF THE INVENTION

The present invention relates to a case or attachment for an electronic communications device. In particular, the invention relates to a case or attachment including a passive antenna.

### BACKGROUND TO THE INVENTION

A current trend is to have relatively large display screens on mobile phones (referred to in other countries as cell phones or hand phones). It is not uncommon for these screens to extend over a large portion of the front surface of a mobile phone. This can make a mobile phone fragile as the screen is often made of glass. Consequently, protective casings have become increasingly common in order to protect mobile phones from damage.

Known protective casings include hard plastic cases having a front and a rear that are attached around edges of a mobile phone, cases which are glued to a mobile phone, and rubber cases or silicone cases which are stretched around a mobile phone and held in place by the resilience of the silicon material.

Mobile phones, and in particular, smart phones capable of transmitting and receiving both voice and data signals, are being used more often. Consequently, users are spending more time speaking to others using their mobile phones and hence, they are holding the mobile phone in close proximity to their head for increasingly greater cumulative periods of time.

Mobile telephones use electromagnetic radiation to communicate with a base station. The World Health Organisation has classified mobile phone radiation as possibly carcinogenic and recommend that users reduce their exposure to the electromagnetic radiation emitted from mobile phones. There is therefore a concern by some users that the radiation from mobile phones may be harmful.

Despite repeated recommendations to use a headset arrangement, users mostly prefer to hold a mobile phone in close proximity to their head when conversing over the mobile phone.

### SUMMARY OF THE INVENTION

According to one aspect, the invention provides An electronic communications device case, including a protective shell of base material having a rear panel and edges adapted to grip outer surfaces of said communications device, the base material having suitable properties to form a protective shell and including added materials exhibiting dielectric properties, and a passive antenna incorporated within or firmly attached to said protective shell, said passive antenna including a plurality of antenna segments, wherein, when in use, electromagnetic radiation from said communications device is directed away from a user.

In another aspect, the present invention provides an attachment for an electronic communications device including a substantially planar portion of base material including added materials exhibiting dielectric properties, and a passive antenna incorporated within or firmly attached to the portion of base material, said antenna including a plurality of antenna segments, wherein, when attached to a rear panel of an electronic communications device and the communications device is in use, electromagnetic radiation from said electronic communications device is directed away from a user.

The electronic communications device may be any device including a mobile phone or a tablet computer or a mobile data device.

The passive antenna is held in sufficiently close proximity to the electronic communications device to become electromagnetically coupled with the electromagnetic field emanating from the device. It is the electromagnetic coupling of the passive antenna that enables the antenna to affect the pattern of radiation emitting from the device and when appropriately configured, the passive antenna causes the radiation emanating from the device in the direction of a user to be significantly reduced.

In an embodiment, the base material includes added materials that exhibit dielectric properties. The added material includes any one or more of Al₂O₃, B₂O₃, MgO, Fe₂O₃, Na₂O, K₂O, CaO, P₂O₅, TiO₂ and/or FeO. The base material may be any material that has the necessary properties to form either a protective shell for a device or an attachment to a device and in embodiment, the base material is PVC (PolyVinyl Chloride) or Silicon

In one embodiment, the protective shell has openings for a display, an earphone adapter and/or a charging port. In another embodiment, the attachment has similar apertures to accommodate the lens of a camera.

In other embodiments, the passive antenna includes a v-shaped segment, a chevron-shaped segment, and a horizontal segment located on an axis relative to the connected segment, wherein the horizontal segment is located between the v-shaped segment and the chevron-shaped segment.

The passive antenna may include a plurality of horizontal segments, wherein each horizontal segment is substantially perpendicular to an axis of the connected segment.

### BRIEF DESCRIPTION OF THE DRAWINGS

To assist in understanding the invention and to enable a person skilled in the art to put the invention into practical effect, embodiments of the invention are described below by way of example with reference to the specific example of the electronic communications device being a mobile phone and with reference to the accompanying drawings, in which:

FIG. 1A illustrates a side view of a mobile phone case according to an embodiment of the present invention;

FIG. 1B illustrates a rear view of the mobile phone case of FIG. 1A;

FIG. 1C illustrates a front view of the mobile phone case of FIG. 1A;

FIG. 2 illustrates a passive antenna according to an embodiment of the present invention;

FIG. 3 illustrates a passive antenna according to another embodiment of the present invention; and

FIG. 4 illustrates an attachment for a mobile phone with passive antenna elements firmly attached to the attachment.

Those skilled in the art will appreciate that minor deviations from the layout of components as illustrated in the drawings will not detract from the proper functioning of the disclosed embodiments of the present invention.

### DETAILED DESCRIPTION OF EMBODIMENTS OF THE INVENTION

Elements of the invention are illustrated in concise outline form in the drawings, showing only those specific details that are necessary to the understanding of the embodiments of the present invention, but so as not to clutter the disclosure with excessive detail that will be obvious to skilled readers.

In this patent specification, adjectives such as first and second, left and right, front and back, top and bottom, etc., are used solely to define one element or method step from another element or method step without necessarily requiring a specific relative position or sequence that is described by the adjectives.

Containing a passive antenna within a base material to form a mobile phone case or attachment results in the reduction of electromagnetic radiation emitted toward a user from the mobile phone, whilst not substantially decreasing signal strength of the mobile phone. The resulting case allows the mobile telephone to function over a wide range of frequencies such that the mobile telephone case may be used for any mobile phone anywhere in the world with equal effectiveness. The case also protects the mobile phone, and provides a grip for a user to hold the phone. The attachment allows a user to keep their existing mobile phone case yet enjoying the benefits of having a passive antenna located in sufficiently close proximity to the antenna of the mobile phone such that the respective antenna became electromagnetically coupled.

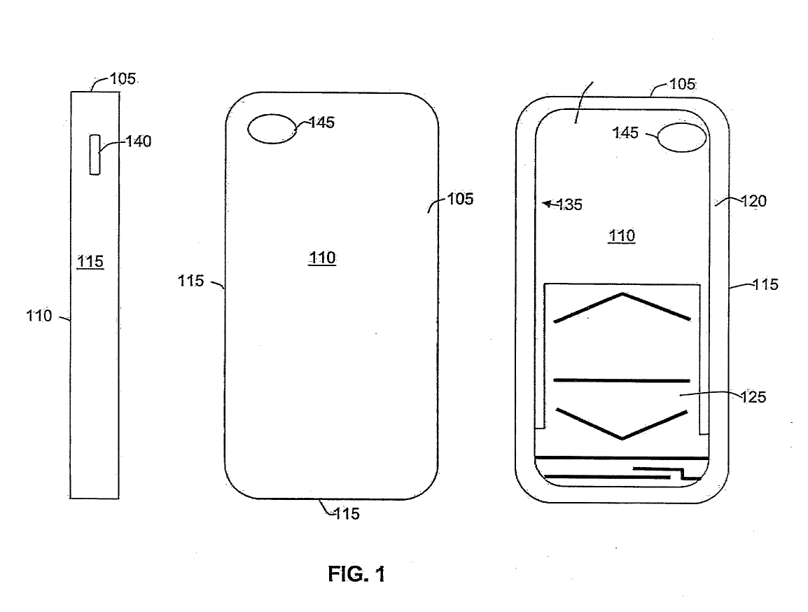

FIG. 1A illustrates a side view, FIG. 1B illustrates a rear view, and FIG. 1C illustrates a front view of a mobile phone case 100 according to an embodiment of the present invention.

The mobile phone case 100 includes a protective shell 105 which is made of PVC or silicon. In the instance of PVC, the case provides a hard protective shell for the mobile phone. In the case of silicon, the material is not as hard as PVC but provides a relatively non-slip surface for the user to grasp. The protective shell 105 grips outer surfaces of a mobile telephone. This occurs by substantially enclosing a rear portion of the telephone by a rear panel 110 of the protective shell 105, substantially enclosing sides of the telephone by side panels 115 of the protective shell 105, and by partially enclosing a front portion of the telephone by a front lip 120 of the protective shell.

According to some embodiments, a silicon case is resilient and is stretched over a mobile telephone. The silicon case may be removed and reused multiple times, and gluing, cutting, or any other form of modification of the telephone case 100 to firmly engage the case with a mobile telephone is not required.

Partially enclosing a front portion of the telephone by the front lip 120, provides an opening for a display of the telephone. This enables the display to be clearly seen and, in the case of a touch screen, allows for uninhibited use of the touch screen.

The telephone case 100 includes a passive antenna 125 incorporated into a panel of the protective shell 105. The passive antenna 125 is attached to an inner side 130 of the rear panel 110 and an inner side 135 of the side panels 115. As will be understood by a person skilled in the relevant field of technology, the passive antenna 125 may be attached to the protective shell by glue, or by any other means. Alternatively, the passive antenna 125 may be incorporated into the protective shell 105 by other means, for example by being heat pressed into the protective shell 105 or by being incorporated into the protective shell 105 during molding of said protective shell 105.

In use, the passive antenna 125 directs radio waves away from a user's head by re-directing radio waves from the mobile telephone in a direction outward from the rear panel 110 of said protective shell.

The protective shell 105 additionally includes an opening 140 for an earphone adapter and a charging port and an opening 145 for a camera lens. As will be understood by a person skilled in the relevant field of technology, a plurality of openings 140 may be present for any number of external connections, displays, microphones, camera lenses and/or buttons on the telephone and/or for aesthetic purposes.

Adding dielectric materials to the base material of the case has the effect of filtering electromagnetic radiation emanating from the mobile phone that reside substantially outside the frequency range that is effective for electronic communications of the mobile phone. This can have a substantial effect upon the total radiation direction toward a user of an electronic communications device.

In one particular embodiment, of all the added materials exhibiting dielectric properties, the relative properties of the additives are as follows:

AL₂O₃ (37.1%), SiO₂ (33.83%), B₂O₃ (10.01%), MgO (5.70%), Fe₂O₃ (9.28%), Na₂O (1.91%)

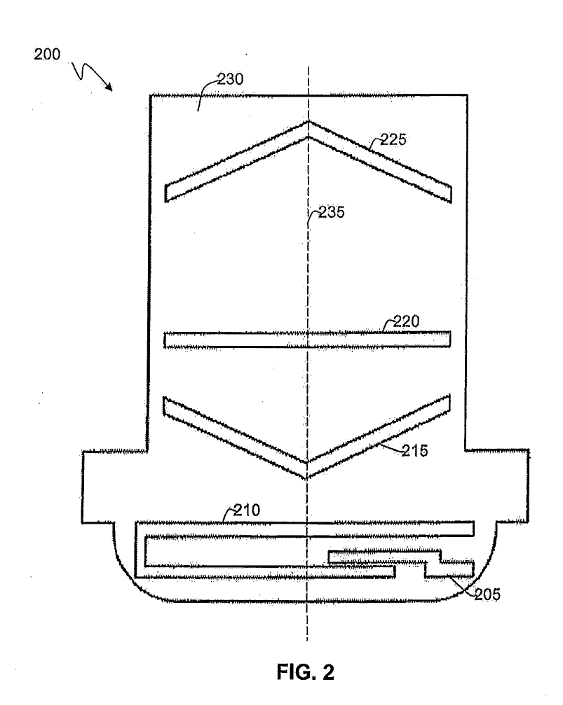

FIG. 2 illustrates a passive antenna 200 according to an embodiment of the present invention. The passive antenna 200 may be incorporated into the protective shell 105 of FIG. 1 similar to the arrangement of passive antenna 125.

The passive antenna 200 is adapted to re-direct radio waves from a mobile telephone in a direction outward from a rear panel of the protective shell, i.e. away from a user's head when held in a typical manner.

The passive antenna 200 includes a plurality of linear antenna segments including a first segment 205, a second segment 210, a v-shaped segment 215, a horizontal segment 220 and a chevron-shaped segment 225.

The plurality of linear antenna segments are formed of a conductive material, for example, copper. The plurality of linear antenna segments are attached to a non-conductive panel 230. The non-conductive panel may be attached to a protective casing, such as the protective shell 105 of FIG. 1. Alternatively, the non-conductive panel may be part of a protective casing.

The plurality of linear antenna segments may include an open loop configuration, a closed loop configuration and/or a Yagi configuration.

The first segment 205, the second segment 210 and the remaining segments, 215, 220 and 225 are, in use, electromagnetically coupled to the radiation emitted from an antenna component of a mobile phone. This is achieved by folding the passive antenna 200 around the mobile telephone and holding a conductive component thereof in close proximity to an antenna which may be incorporated into side portions of the mobile phone. Examples of mobile phones including an antenna incorporated into side portions include the iPhone 4, from Apple Computer Inc, California, USA.

The v-shaped segment 215, the chevron-shaped segment 225, and the horizontal segment 220 are located on an axis 235 relative to the first segment 205 and the second segment 210. The horizontal segment 220 is located between the v-shaped segment 215 and the chevron-shaped segment 225.

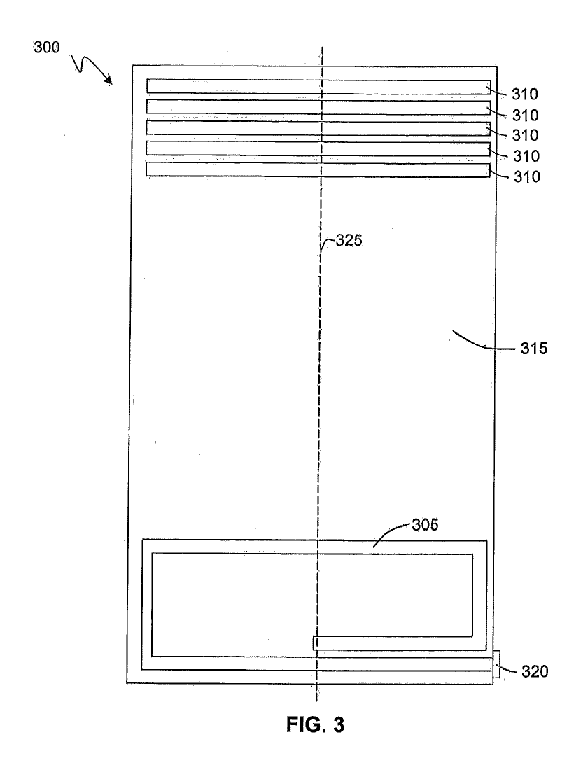

FIG. 3 illustrates a passive antenna 300 according to an embodiment of the present invention.

The passive antenna 300 is similar to the passive antenna 200 and is also adapted to direct radio waves.

The passive antenna 300 includes a plurality of linear antenna segments including a connected segment 305 and a plurality of horizontal segments 310.

The plurality of linear antenna segments are formed of a conductive material and are attached to a non-conductive panel 315 similar to the plurality of linear antenna segments of FIG. 2.

The segments 305 and 310 are, in use, electromagnetically coupled to an antenna component of a mobile telephone.

The plurality of horizontal segments 310 are substantially perpendicular to an axis 325 of the connected segment 305.

The passive antenna 125, 200, 300 incorporated into a protective shell of silicon was found to reduce specific absorption rates (SAR) of radiation while positioned adjacent a user's head. The test frequencies included 898 MHz, 836.6 MHz, 1747 Mhz and 1950 MHz and results are shown in Table 1 to Table 4. An iPhone 4 was used as the test terminal.

TABLE 1
SAR Measurement for 900 MHz

| | Test | SAR Level |
|---|---|---|
| | Freq. | for (10 g) |
| Test Position | (MHz) | mW/g |
| Touch Left No | 898 | 0.524 |
| Case | | |
| Touch Left | 898 | 0.135 |
| With Case | | |
| Touch Right | 898 | 0.404 |
| No Case | | |
| Touch Right | 898 | 0.104 |
| with Case | | |

TABLE 2
SAR Measurement for 1800 MHz

| | Test | SAR Level |
|---|---|---|
| | Freq. | for (10 g) |
| Test Position | (MHz) | mW/g |
| Touch Left No | 1747 | 0.539 |
| Case | | |
| Touch Left | 1747 | 0.442 |
| With Case | | |
| Touch Right No | 1747 | 0.437 |
| Case | | |
| Touch Right | 1747 | 0.256 |
| With Case | | |

TABLE 3
SAR Measurement for 1950 MHz

| | Test | SAR Level |
|---|---|---|
| | Freq. | for (10 g) |
| Test Position | (MHz) | mW/g |
| Touch Left No | 1950 | 0.850 |
| Case | | |
| Touch Left | 1950 | 0.719 |
| With Case | | |
| Touch Right No | 1950 | 0.754 |
| Case | | |
| Touch Right | 1950 | 0.656 |
| With Case | | |

TABLE 4
SAR Measurement for 850 MHz

| | Test | SAR Level |
|---|---|---|
| | Freq. | for (10 g) |
| Test Position | (MHz) | mW/g |
| Touch Left No | 836.6 | 0.806 |
| Case | | |
| Touch Left | 836.6 | 0.493 |
| With Case | | |
| Touch Right No | 836.6 | 0.602 |
| Case | | |
| Touch Right | 836.6 | 0.467 |
| With Case | | |

The same frequencies as used in Table 1 to Table 4 were tested to determine if there was a reduction or increase in the transmitted field strength. The results are shown in Table 5 to Table 8.

TABLE 5
Peak Field Strength Measurement for 900 MHz

| Test | Radiated Field |
|---|---|
| Freq. | Strength |
| (MHz) | at 10 m |
| 836.6 | Approx. 8 dB lower |
| | with case |

TABLE 6
Peak Field Strength Measurement for 1800 MHz

| Test | Radiated Field |
|---|---|
| Freq. | Strength |
| (MHz) | at 10 m |
| 1747 | Approx. 6 dB |
| | higher with case |

TABLE 7
Peak Field Strength Measurement for 2100 MHz

| Test | Radiated Field |
|---|---|
| Freq. | Strength |
| (MHz) | at 10 m |
| 1950 | Approx. 6 dB |
| | higher with case |

TABLE 8
Peak Field Strength Measurement for 850 MHz

| Test | Radiated Field |
|---|---|
| Freq. | Strength |
| (MHz) | at 10 m |
| 836.6 | Approx. 4 dB |
| | higher with case |

The results of Table 1 to Table 8 indicate that, when the passive antenna 125, 200, 300 is incorporated into a protective shell or attachment of base material, the SAR value is reduced for all tested frequencies and the signal strength is increased for three of four tested frequencies.

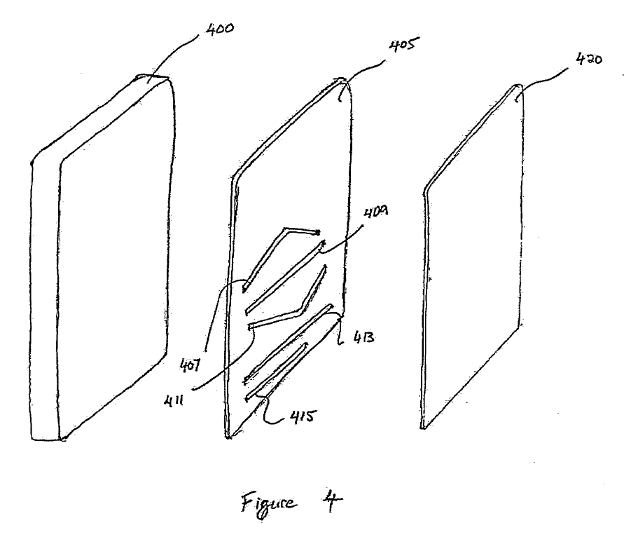

With reference to FIG. 4, an attachment to an mobile phone is illustrated.

The mobile phone 400 is illustrated in a perspective view displaying the rear face 402 of the mobile phone.

An attachment 405 is also illustrated, to which, passive antenna elements 407, 409, 411, 413 and 415 are firmly attached to the attachment 405. The attachment may be formed from any base material such as PVC, Silicon or any other material that enables the attachment to be affixed to the rear face 402 of the mobile phone 400. The attachment 405 may be affixed to the mobile phone 400 by adhesive.

In one embodiment, the attachment 405 is configured to be substantially the same size and shape as the rear face 402 of the mobile phone 400 which assists users when affixing the attachment 405 to correctly and accurately physically locate the passive antenna elements 407, 409, 411, 413 and 415 with respect to the antenna of the mobile phone 400.

The passive antenna elements 407, 409, 411, 413 and 415 may be incorporated within the material of the attachment 405 or may be affixed to a surface of the attachment 405. If the passive antenna elements are affixed to the side of the attachment 405 that is affixed to the rear face 402 of the mobile phone 400, then the attachment 405 acts to protect the passive antenna elements 407, 4049, 411, 413 and 415.

In another embodiment, the passive antenna elements are affixed to the outer surface of the attachment 405 and mobile portion of base material 420 is affixed to the outer surface of the attachment 405 thereby “sandwiching” the passive antenna elements between the attachment 405 and the additional portion of material 420. The additional portion of material 420 may include additives exhibiting dielectric properties and may be a different base material as compared with that of the attachment 405.

In summary, the present invention reduces electromagnetic radiation levels directed toward a user from an electronic communications device whilst not substantially decreasing the signal strength of the device. By using a base materials with additives that exhibit dielectric properties, the device case or attachment incorporating a passive antenna according to the present invention functions over a wide range of frequencies and reduces the electromagnetic radiation directed toward a user. The use of a base material for the case or attachment with dielectric additives in communication with a passive antenna gives rise to the surprising result reducing the radiation emanating toward a user across a sufficiently broad range of frequencies such that the phone case or attachment according to the present invention will operate effectively in all countries around the world that operate call communications network. In contrast, cases made of other materials such as plastic that incorporate a passive antenna have been found to only operate at selected frequencies and hence cannot function in all countries around the world.

The above description is not intended to be exhaustive or to limit the invention to a single disclosed embodiment. As mentioned above, numerous alternatives and variations to the present invention will be apparent to those skilled in the relevant field of technology. Accordingly, while some alternative embodiments have been discussed specifically, other embodiments will be apparent or relatively easily developed, by those of requisite skill. Accordingly, this patent specification is intended to embrace all alternatives, modifications and variations of the present invention that have been discussed herein, and other embodiments that fall within the spirit and scope of the above described invention.

The reference to any prior art in this specification is not, and should not be taken as, an acknowledgement or any suggestion that the prior art forms part of the common general knowledge in Australia.

1-15. (canceled)

16. An electronic communications device case, including:
a protective shell of base material having a rear panel and edges adapted to grip outer surfaces of said communications device, the base material having suitable properties to form a protective shell and including added materials exhibiting dielectric properties; and
a passive antenna incorporated within or firmly attached to said protective shell, said passive antenna including a plurality of antenna segments;
wherein, when in use, electromagnetic radiation from said communications device is directed away from a user.

17. An attachment for an electronic communications device including a substantially planar portion of base material including added materials exhibiting dielectric properties; and
a passive antenna incorporated within or firmly attached to the portion of base material, said antenna including a plurality of antenna segments;
wherein, when attached to a rear panel of an electronic communications device and the communications device is in use, electromagnetic radiation from said electronic communications device is directed away from a user.

18. An electronic communications device case or attachment according to claim 16, wherein said materials exhibiting dielectric properties include any one or more of Al₂O₃, B₂O₃, MgO, Fe₂O₃, Na₂O, K₂O, CaO, P₂O₅, TiO₂ and/or FeO.

19. An electronic communications device case or attachment according to claim 16, wherein said passive antenna includes at least one of an open loop configuration, a closed loop configuration, a Yagi configuration, a V-shaped segment, a chevron shaped segment, or one or more linear segments.

20. An electronic communications device case or attachment according to claim 16, wherein at least one segment of said plurality of antenna segments of said passive antenna is electromagnetically coupled to an antenna component of said electronic communications device.

21. An electronic communications device case or attachment according to claim 16, wherein the base material is silicon.

22. An electronic communications device case or attachment according to claim 16, wherein the base material is PolyVinyl Chloride (PVC).

23. An electronic communications device case or attachment according to claim 19, wherein said passive antenna includes a plurality of substantially parallel segments.

24. An electronic communications device case or attachment according to claim 16, wherein the elements of the passive antenna are substantially linear.

25. An attachment of an electronic communications device according to claim 17, wherein the base material is adhered to said rear panel of said electronic communications device.

26. An attachment for an electronic communications device according to claim 25, wherein the substantially planar portion of base material is configured to substantially the same physical characteristics of the rear panel of the device such that aligning and adhering the base material to the rear panel of the device effectively aligns the passive antenna with the electronic communications device to achieve electromagnetic coupling therebetween.

27. An attachment for an electronic communications device according to claim 17, wherein the base material, when secured to a rear panel of said device, resides substantially between the rear and the passive antenna.

28. An electronic communications device case or attachment according to claim 16, substantially as hereinbefore described with reference to the accompanying drawings.
